(19) United States
(12) Patent Application Publication
(10) Pub. No.: US 2007/0268457 A1
(43) Pub. Date: Nov. 22, 2007

(54) Motor vehicle having a display region or illuminated region

(75) Inventors: Pao Chen, Milpitas, CA (US); Derek Pai, San Francisco, CA (US); Brian Ng, Los Altos, CA (US); Arne Stoschek, Palo Alto, CA (US)

Correspondence Address: LERNER GREENBERG STEMER LLP, P O BOX 2480, HOLLYWOOD, FL, 33022-2480, US

(73) Assignee: Volkswagen Aktiengesellschaft

(21) Appl. No.: 11/437,574

(22) Filed: May 19, 2006

(51) Int. Cl. G03B 21/00

(52) U.S. Cl. 353/13

(57) ABSTRACT

A motor vehicle has a passenger compartment with an interior covering formed with a display region. The display regions is configured to emit visible light upon irradiation thereof with light in an invisible range or an at least virtually invisible range. There is also provided a projection assembly for displaying information or images in the display region by irradiating the display region with such light in the invisible range or the at least virtually invisible range.

### BACKGROUND OF THE INVENTION

### Field of the Invention

The invention lies in the automotive technology field. More specifically, the invention relates to a motor vehicle having a display region for displaying information and/or images.

Display units are arranged in motor vehicles for the purpose, in particular, of displaying information. Such a display unit is disclosed, for example, in European patent EP 0 345 727 B1 and its counterpart U.S. Pat. No. 5,044,304. That display unit comprises a housing having a closed region and an open region, and having a transparent cover of the open region of the housing. The display unit further comprises a movable part arranged in the closed region of the housing, a shaft extending from the movable part to the transparent cover, and a display panel that has display elements and an opening through which the shaft passes. A pointer is connected to the shaft in such a way that an elongated display region formed thereon can be swiveled over the front side of the display panel. An ultraviolet lamp is arranged in front of the display panel and the pointer. The elongated display region has a single, elongated surface that is oriented toward the normal viewing position in the vehicle and has a fluorescing substance.

A display apparatus having an assigned fluorescing lamp is further disclosed in U.S. Pat. No. 6,210,011.

International PCT publication WO 98/10957 discloses a dashboard for a motor vehicle having a light source and fluorescing material. U.S. Pat. No. 6,471,368 discloses a ring that is arranged at a headlight and has fluorescing material.

### SUMMARY OF THE INVENTION

It is accordingly an object of the invention to provide a motor vehicle and a display and illumination system which overcome the above-mentioned disadvantages of the heretofore-known devices and methods of this general type and which improves the presentation of information in a motor vehicle and/or improves the operability of a motor vehicle. It is a further object of the invention to improve the lighting conditions in a motor vehicle with little outlay.

With the foregoing and other objects in view there is provided, in accordance with the invention, a motor vehicle, comprising:
a passenger compartment with an interior covering formed with a display region configured to emit visible light upon irradiation of said display region by light in a substantially invisible range; and
a projection assembly for displaying information or images in said display region by irradiating said display region by light in the substantially invisible range.

In other words, the above and other objects of the invention are achieved with a motor vehicle having a passenger compartment with an interior covering that comprises a display region for emitting visible light upon irradiation of the display region by light in an invisible range or an at least virtually invisible range, the motor vehicle comprising a projection assembly for displaying information and/or images in the display region by irradiating the display region by light in the invisible range or the at least virtually invisible range.

The term “display region” as used herein means a region that comprises a fluorescing and/or phosphorescing, in particular red, green and/or blue, color or a fluorescing and/or phosphorescing, in particular red, green and/or blue, doping. A display region in the meaning of the invention comprises, in particular, a light emission layer. A light emission layer in the meaning of the invention is, in particular, a fluorescing and/or phosphorescing layer. Such a fluorescing and/or phosphorescing layer can, for example, be a carrier layer doped with red, green and/or blue fluorescing and/or phosphorescing dye. A light emission layer in the meaning of the invention can also be a stack of fluorescing and/or phosphorescing layers.

An “interior covering,” as used in this context is intended, in particular, also to comprise the covering of seats in the passenger compartment.

In a further refinement of the invention, the projection assembly comprises a light source for emitting light in the invisible range or the at least virtually invisible range.

In a further refinement of the invention, the projection assembly comprises a controllable image generator arranged in the light path between the light source and the display region. In a further refinement of the invention, the projection assembly is configured as a controllable image generator for generating an optical image to be displayed. A controllable image generator in the meaning of the invention can be a controllable reflector or a controllable refractor. Such a refractor in the meaning of the invention can be a so-called photonic crystal or a switchable Bragg grating. Suitable refractors can, for example, be obtained from POC Physical Optics Corporation (www.poc.com). Suitable projection assemblys are described, for example, in U.S. patent application U.S. 60/640,292, which is herewith incorporated by reference.

In a further refinement of the invention, the display region is arranged on a dashboard.

In a further refinement of the invention, the display region is arranged on the rear side of a seat. In a further refinement of the invention, the display region is arranged on the rear side of a headrest of a seat.

In a further refinement of the invention, the display region is arranged on a control.

In a further refinement of the invention, the light in the at least virtually invisible range is UV light.

In a further refinement of the invention, to a substantial proportion, the light in the at least virtually invisible range is light with a wavelength of approximately 405 nm±10 nm.

In a further refinement of the invention, the light in the at least virtually invisible range is substantially light with a wavelength of approximately 405 nm±10 nm.

In a further refinement of the invention, to an overwhelming proportion, the light in the at least virtually invisible range is light with a wavelength of approximately 405 nm±10 nm.

The above-mentioned object is additionally achieved by means of a motor vehicle that comprises a control for controlling at least a function of the motor vehicle, the control comprising an illuminated region for emitting visible light upon irradiation of the illuminated region by light in an invisible range or an at least virtually invisible range, and the motor vehicle comprising a light source for irradiating the illuminated region by light in the invisible range or the at least virtually invisible range. The invisible or virtually invisible light can be near ultraviolet light, ultraviolet light, near infrared light or infrared light. The light source can be or comprise, for example, an abovementioned projection assembly, an LED, a CCFL or an OLED.

An illuminated region in the meaning of the invention is, in particular, a region that comprises a fluorescing and/or phosphorescing, in particular red, green and/or blue, dye or a fluorescing and/or phosphorescing, in particular red, green and/or blue, doping.

In a further refinement of the invention, to a substantial proportion, the light in the at least virtually invisible range is light with a wavelength of approximately 405 nm±10 nm.

In a further refinement of the invention, the light in the at least virtually invisible range is substantially light with a wavelength of approximately 405 nm±10 nm.

In a further refinement of the invention, to an overwhelming proportion, the light in the at least virtually invisible range is light with a wavelength of approximately 405 nm±10 nm.

In a further refinement of the invention, the illuminated region comprises a first fluorescing and/or phosphorescing substance for emitting light in a visible range upon irradiation by light in a first at least virtually invisible range, and a second fluorescing and/or phosphorescing substance for emitting light in a visible range upon irradiation by light in a second at least virtually invisible range differing from the first at least virtually invisible range.

In a further refinement of the invention, the light source is optionally configured for irradiating the control either by light in the first at least virtually invisible range or by light in the second at least virtually invisible range.

In a further refinement of the invention, the control is assigned a first function and at least one second function differing from the first function, the light source being configured for irradiating the control by light in the first at least virtually invisible range when the control is assigned the first function, and for irradiating the control by light in the second at least virtually invisible range when the control is assigned the second function.

The abovementioned object is achieved, in addition, by means of a motor vehicle that comprises a control for operating at least two functions of the motor vehicle or for operating a first function of the motor vehicle and at least one second function of the motor vehicle, the control comprising a first fluorescing and/or phosphorescing substance for emitting light in a visible range upon irradiation by light in a first at least virtually invisible range, and a second fluorescing and/or phosphorescing substance for emitting light in a visible range upon irradiation by light in a second at least virtually invisible range differing from the first at least virtually invisible range, and the motor vehicle comprising a light source optionally for irradiating the control either by light in the first at least virtually invisible range or by light in the second at least virtually invisible range. The invisible light can be near ultraviolet light, ultraviolet light, near infrared light or infrared light. The light source can be or comprise, for example, an abovementioned projection assembly, an LED, a CCFL or an OLED.

In one refinement of the invention, the light source is configured for irradiating the control by light in the first at least virtually invisible range when the control is assigned the first function, and for irradiating the control by light in the second at least virtually invisible range when the control is assigned the second function.

The abovementioned further object is achieved, in addition, by means of a motor vehicle having an interior covering for covering an interior of the motor vehicle, a part of the interior covering being configured as an illuminated region with a fluorescing and/or phosphorescing substance for emitting visible light upon irradiation by light in an invisible range or an at least virtually invisible range, and the motor vehicle comprising a light source for irradiating a side, facing the interior of the motor vehicle, of the illuminated region by light in the invisible range or the at least virtually invisible range. The invisible light can be near ultraviolet light, ultraviolet light, near infrared light or infrared light. The light source can, for example, be or comprise an abovementioned projection assembly, an LED, a CCFL or an OLED.

In one refinement of the invention, the illuminated region is arranged in a footwell of the interior.

In a further refinement of the invention, to an overwhelming proportion, the light in the at least virtually invisible range is light with a wavelength of approximately 405 nm±10 nm.

The abovementioned further object is achieved, in addition, by means of a motor vehicle having a trim strip that is arranged in an interior of the motor vehicle and comprises a fluorescing and/or phosphorescing substance for emitting light in a visible range upon irradiation by light in an at least virtually invisible range, the motor vehicle comprising a light source for irradiating a side, facing the interior of the motor vehicle, of the trim strip by light in the at least virtually invisible range. An interior in this sense can be, for example, a passenger compartment, a trunk or an engine compartment. The invisible light can be near ultraviolet light, ultraviolet light, near infrared light or infrared light. The light source can, for example, be or comprise an abovementioned projection assembly, an LED, a CCFL or an OLED.

In one refinement of the invention, the light source is coupled to a low beam of the motor vehicle. It is provided in this case, in particular, that the light source is switched on automatically when the low beam is switched on.

A fluorescing and/or phosphorescing substance in the meaning of the inventions can also be a mixture of various fluorescing and/or phosphorescing substances.

In the meaning of the invention, light in an invisible range is light of a wavelength in a region in which light is invisible to the average human eye. In the meaning of the invention, light in an at least virtually invisible range is light of a wavelength in a region in which light is at least virtually invisible to the average human eye.

A motor vehicle in the sense of the inventions is, in particular, a land vehicle that can be used individually in road traffic. Motor vehicles in the meaning of the invention are, in particular, not restricted to land vehicles with an internal combustion engine.

Other features which are considered as characteristic for the invention are set forth in the appended claims.

Although the invention is illustrated and described herein as embodied in a motor vehicle having a display region or illuminated region, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a partly broken-away side view of an exemplary embodiment of a motor vehicle;

FIG. 2 is a partial perspective view of an exemplary embodiment of a display region, arranged on a dashboard, in a display state;

FIG. 3 is a similar view of the display region in accordance with FIG. 2, in a rest state;

FIG. 4 shows an exemplary embodiment of a display region, arranged on the rear side of headrest, in a display state;

FIG. 5 shows the display region in accordance with FIG. 4 in a rest state;

FIG. 6 is a schematic view of an exemplary embodiment of a projection assembly;

FIG. 7 shows a further exemplary embodiment of a projection assembly;

FIG. 8 shows a further exemplary embodiment of a projection assembly;

FIG. 9 shows a further exemplary embodiment of a motor vehicle;

FIG. 10 shows a diagrammatic illustration of an exemplary embodiment of an assembly for illuminating a control;

FIG. 11 shows an exemplary embodiment of a control;

FIG. 12 shows the control in accordance with FIG. 11, in another state;

FIG. 13 shows the control in accordance with FIG. 11, in a rest state;

FIG. 14 shows an exemplary embodiment of a footwell; and

FIG. 15 shows an exemplary embodiment of an engine compartment.

### DETAILED DESCRIPTION OF PREFERRED EXEMPLARY EMBODIMENTS

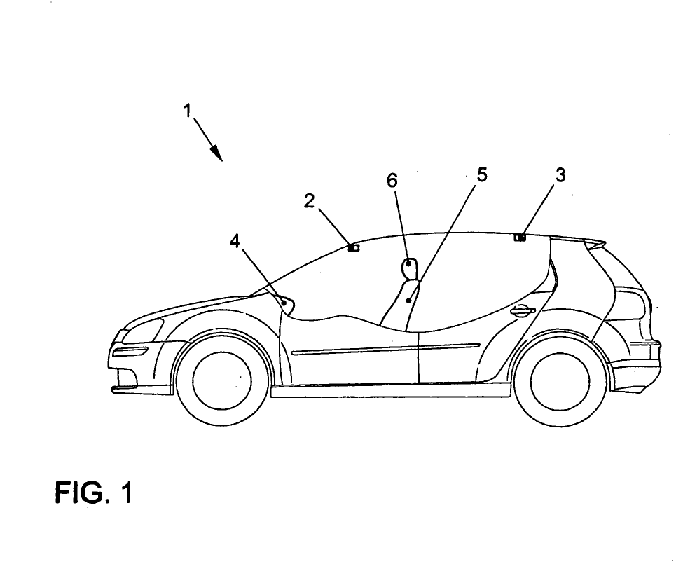

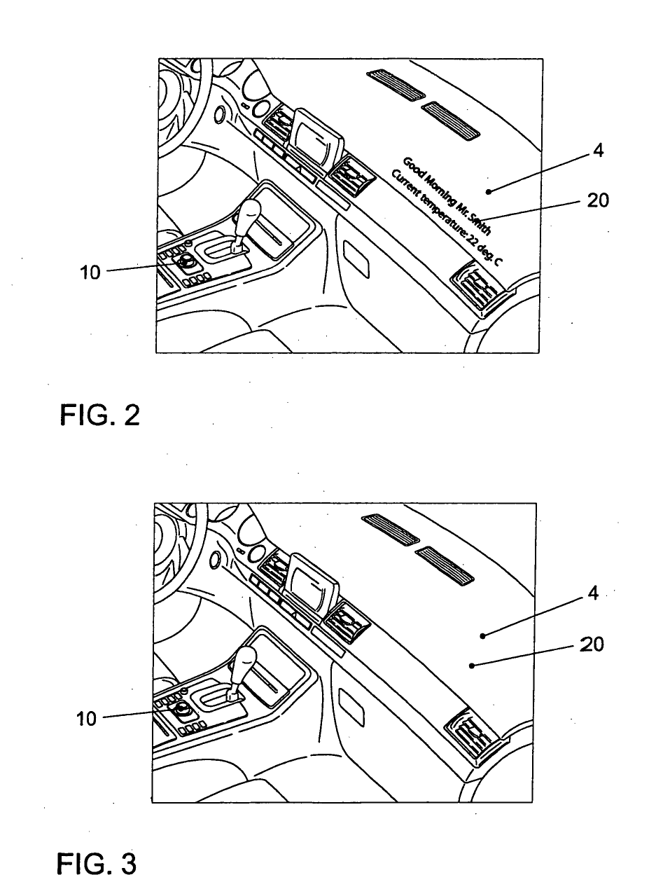

Referring now to the drawing figures in detail and first, particularly, to FIG. 1 thereof, there is shown an exemplary embodiment of a motor vehicle 1. On a dashboard 4 of the motor vehicle 1 there is provided a display region 20. The latter, which is illustrated in detail in FIG. 2 and FIG. 3, is configured to emit visible light upon irradiation of the display region 20 by light in an invisible range or an at least virtually invisible range. The motor vehicle 1 also comprises a projection assembly 2 for displaying information or images in the display region 20 by irradiating the display region 20 by light in the invisible range or the at least virtually invisible range. In a preferred refinement, the light in the at least virtually invisible range is primarily light of a wavelength of approximately 405 nm±10 nm. The term “primarily” is to be understood here as connoting a substantial and functionally dominant portion.

The display region 20 comprises, for example, a fluorescing and/or phosphorescing, in particular red, green and/or blue, dye or a fluorescing and/or phosphorescing, in particular red, green and/or blue, doping.

FIG. 2 and FIG. 3 show the motor vehicle 1 in a detail of an interior view, FIG. 2 showing the display region 20, arranged on the dashboard 4, in a display state. In this display state, in accordance with the illustrated exemplary embodiment a greeting and a temperature display are displayed by means of the display region 20. To this end, the display region 20 is irradiated appropriately by means of the projection assembly 2 by light in the invisible range (i.e., substantially invisible range). FIG. 3 shows the display region 20 in a rest state in which it is not irradiated by light and displays no information.

Reference numeral 10 denotes a control assembly or control element or operator control device (“control” for short) that is configured as a rotary knob and likewise has on its top side, in one refinement, a display region corresponding to the display region 20. It can be provided in this case that (variable, if appropriate) information is displayed by means of the display region arranged on the control 10. However, it can also be provided that illumination of the control is implemented by means of the display region arranged on the control 10. In this case, the display region arranged on the control 10 is an exemplary embodiment of an illuminated region in the sense of claims 12 to 20.

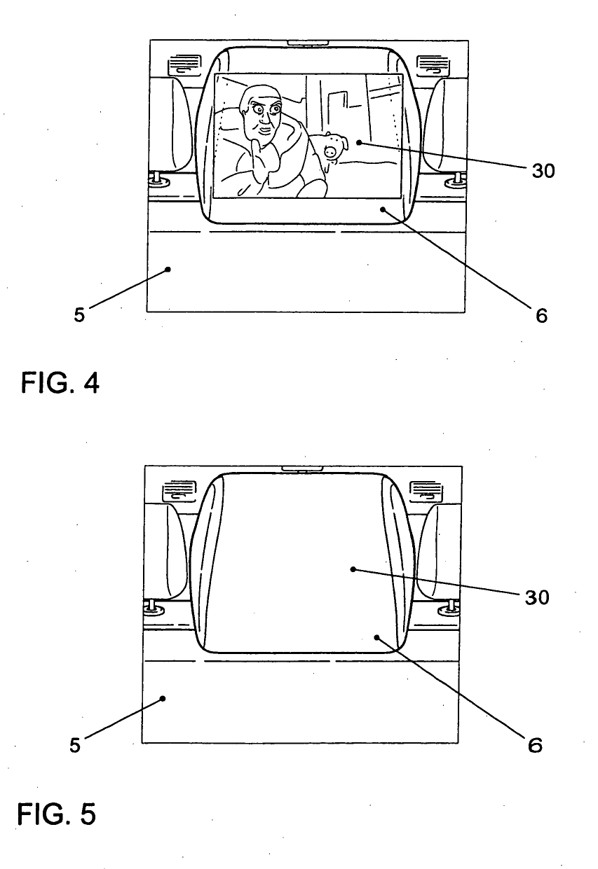

Arranged on the rear side of a headrest 6 of a seat 5 of the motor vehicle 1 is a further display region 30—illustrated in detail in FIG. 4 and FIG. 5—for emitting visible light upon irradiation of the display region 30 by light in an invisible range or an at least virtually invisible range. The motor vehicle 1 additionally comprises a projection assembly 3, assigned to the display region 30, for displaying information or images in the display region 30 by irradiating the display region 30 by light in the invisible range or the at least virtually invisible range.

FIG. 4 shows the display region 30 in a display state. In this display state, moving images are shown by means of the display region 30 in accordance with the exemplary embodiment illustrated. To this end, the display region 30 is irradiated appropriately by means of the projection assembly 3 by light in the invisible range or the at least virtually invisible range. FIG. 5 shows the display region 30 in a rest state in which it is not irradiated by light and displays no image.

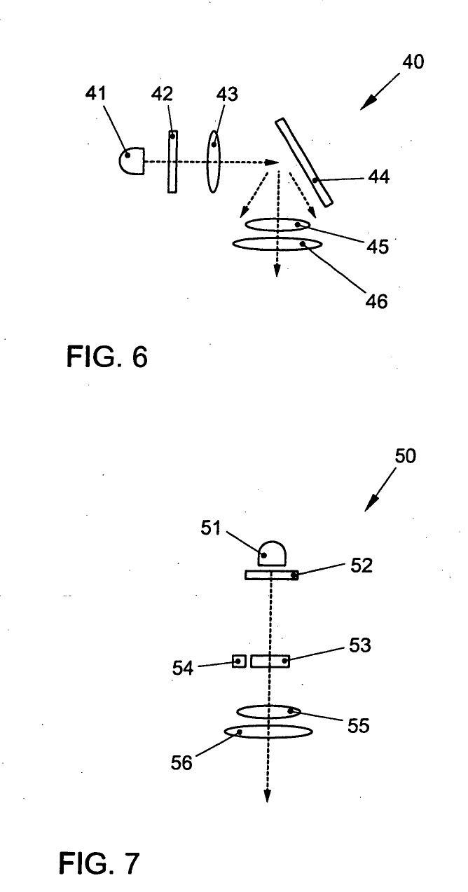

FIG. 6 shows an exemplary embodiment of a projection assembly 40 for use as a projection assembly 2 or 3. The projection assembly 40 comprises a broadband light source 41 (40 nm to 1600 nm wavelength) as, for example, a xenon or mercury lamp, and a light reflecting DLP processor 44 for reflecting light or for coupling out light by means of micromirrors, it being possible to use the DLP processor 44 to generate an image from the light, generated by the broadband light source 41, by means of an appropriate movement of the micromirrors. The projection assembly 40 additionally comprises an optical bandpass filter 42 that is arranged in a light path between the broadband light source 41 and the DLP processor 44 and filters out visible light and infrared light, a front focal lens 43 arranged in the light path between the broadband light source 41 and the DLP processor 44, and two projection lenses denoted by reference numerals 45 and 46. The light reflecting DLP processor 44 is an exemplary embodiment of a controllable image generator in the meaning of the claims.

FIG. 7 shows an exemplary embodiment, alternative to the projection assembly 40, of a projection assembly 50 in a diagrammatic illustration that can likewise be used as projection assembly 2 or 3. The projection assembly 50 comprises a broadband light source 51 (40 nm to 1600 nm wavelength) such as, for example, a xenon or mercury lamp, and a (2D) refractor 53. Such a refractor 53 can be a so-called photonic crystal or a switchable Bragg grating. Suitable refractors can be, for example, obtained from POC Physical Optics Corporation (www.poc.com). The refractor 53 is assigned an actuator 54 for setting the direction of a light path upon passage through the refractor 53. In one configuration of the refractor 53 as photonic crystal, the setting of the direction of the light path upon passage through the refractor 53 is performed acoustically by means of the actuator 54. In one configuration of the refractor 53 as Bragg grating, the setting of the direction of the light path upon passage through the refractor 53 is performed electrically means of the actuator 54. The refractor 53 is an exemplary embodiment of a controllable image generator in the meaning of the claims, the actuator 54 being driven in such a way that an image can be generated upon passage through the refractor 53 from the light generated by the broadband light source 41.

The projection assembly 50 comprises, in addition, an optical bandpass filter 52 that is arranged in a light path between the broadband light source 51 and the refractor 53 and that filters out visible light and infrared light, as well as two projection lenses that are denoted by reference numerals 55 and 56 and are arranged in the light path downstream of the refractor 53.

The combination of the broadband light source 41 and the optical bandpass filter 42 in FIG. 6, and the combination of the broadband light source 51 and the optical bandpass filter 52 in FIG. 7 can be replaced by a narrowband light source such as a solid-state pumped laser or a laser diode.

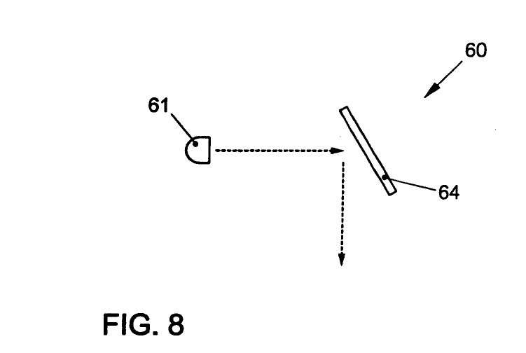

FIG. 8 shows an exemplary embodiment, alternative to the projection assembly 40 or the projection assembly 50, of a projection assembly 60 in a diagrammatic illustration that can likewise be used as a projection assembly 2 or 3. The projection assembly 60 comprises a narrowband light source 61 such as a solid-state pumped laser or a laser diode, and an MEM system 64 (MEM=micro-electro-mechanical), comprising a number of micromirrors, for reflecting light, it being possible by means of the MEM system 64 to generate an image from the light generated by the narrowband light source 61 by appropriate movement of the micromirrors. The MEM system 64 is an exemplary embodiment of a controllable image generator in the meaning of the claims. The MEM system 64 can be configured, for example, as a piezoelectric MEM system or as an electromagnetic MEM system.

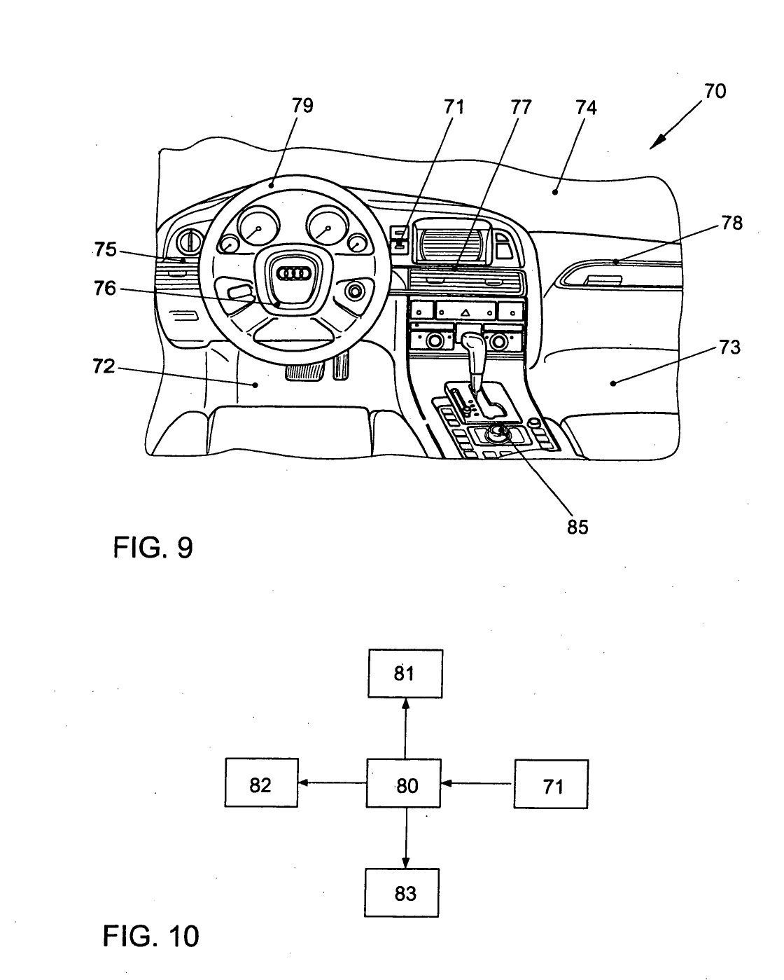

FIG. 9 shows a detail of an inner view of an exemplary embodiment of a motor vehicle 70 having a control, denoted by reference numeral 71, for operating a first function—symbolized in FIG. 10 by a block denoted by reference numeral 82—of the motor vehicle 70, and at least one second function—symbolized in FIG. 10 by a block denoted by reference numeral 83—of the motor vehicle 70. The control 71 comprises a first fluorescing and/or phosphorescing substance for emitting light in a visible range upon irradiation by light in a first at least virtually invisible range, and a second fluorescing and/or phosphorescing substance for emitting light in a visible range upon irradiation by light in a second at least virtually invisible range differing from the first at least virtually invisible range.

The motor vehicle 70 additionally comprises a light source 81, illustrated in FIG. 10, optionally for irradiating the control 71 either by light in the first at least virtually invisible range, or by light in the second at least virtually invisible range. The invisible light can be near ultraviolet light, ultraviolet light, near infrared light and/or infrared light. The light source 81 can, for example, be or comprise a projection assembly corresponding to the projection assembly 2, 3, 40, 50, or 60, an LED, a CCFL or an OLED. The light source 81 an be arranged upstream or downstream of or next to the control 71.

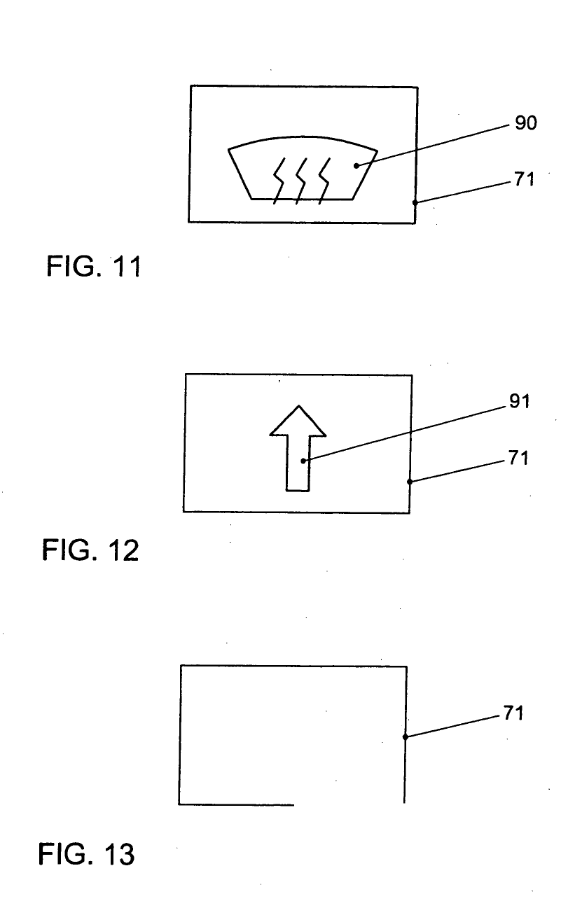

The control 71 is assigned a controller 80 for driving the first function 82, the second function 83 and the light source 81. The controller 80 can in some circumstances be an assembly composed of distributed control units. If the control 71 is provided for operating the first function 82, light is emitted in the first at least virtually invisible range—on the basis of driving appropriately with the aid of the controller 80—by means of the light source 81. As illustrated in FIG. 11, because of this light a symbol 90 symbolizing the operation of the first function 82 lights up on the control 71; said symbol is formed by the first fluorescing and/or phosphorescing substance. By contrast, if the control 71 is provided for operating the second function 83, light is emitted in the second at least virtually invisible range—on the basis of appropriate driving with the aid of the controller 80—by means of the light source 81. As illustrated in FIG. 12, a symbol 91 symbolizing the operation of the second function 83 lights up on the control 71 because of this light; said symbol is formed by the second fluorescing and/or phosphorescing substance. If neither the first function 82 nor the second function 83 can be operated by means of the control 71, no light is emitted by means of the light source 81 and so—as illustrated in FIG. 13—no symbol lights up on the control 71.

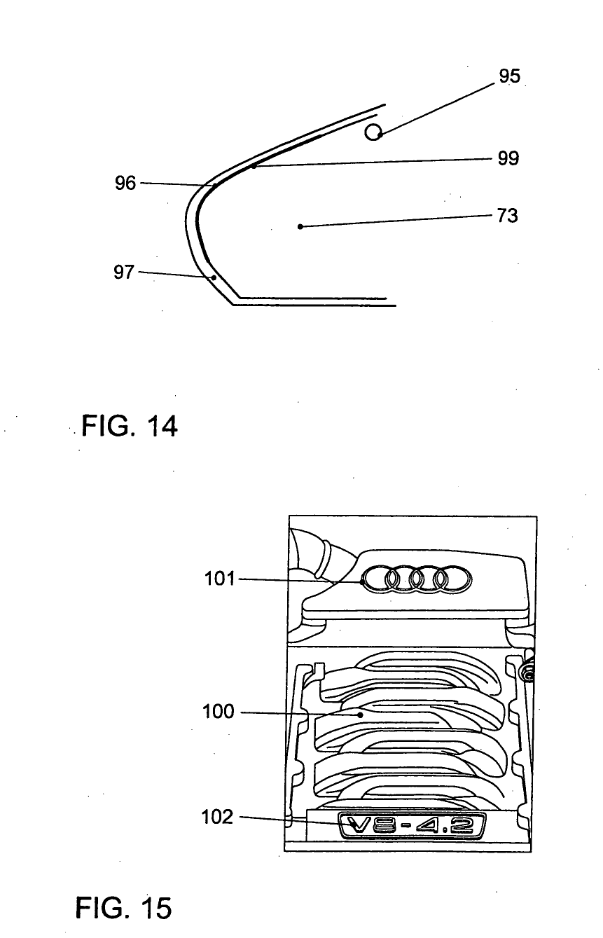

The motor vehicle 70 illustrated in FIG. 9 comprises a footwell 72 and a footwell 73 illustrated in cross section in a simplified fashion in FIG. 14. The footwell 73 comprises an interior covering 97 having an illuminated region 96 with a fluorescing and/or phosphorescing substances for emitting visible light upon irradiation by light in an invisible range or an at least virtually invisible range. Arranged in the footwell 73 is a light source 95 for irradiating a side 99, facing the footwell 73, of the illuminated region by light in the invisible range or the at least virtually invisible range. The light source 95 can, for example, be or comprise a projection assembly corresponding to the projection assembly 2, 3, 40, 50, 60, an LED, a CCFL or an OLED.

The motor vehicle 70 illustrated in FIG. 9 further comprises trim strips 75, 76, 77 and 78, arranged on a dashboard 74 and on a steering wheel 79, having a fluorescing and/or phosphorescing substance for emitting light in a visible range upon irradiation by light in an at least virtually invisible range. The trim strips 75, 76, 77 and 78 are assigned a light source (not illustrated) that corresponds to the light source 95, is arranged on a roofliner, and serves for irradiating the sides, facing the interior of the motor vehicle 70, of the trim strips 75, 76, 77 and 78 by light in the at least virtually invisible range. This light source can be arranged, for example, at the projection assembly 2, illustrated in position in FIG. 1, or next to it. The light source assigned to the trim strips 75, 76, 77 and 78 is coupled to a low beam of the motor vehicle 70 in such a way that the light source assigned to the trim strips 75, 76, 77 and 78 is switched on automatically when the low beam is switched on.

Moreover, the motor vehicle 70 can comprise display regions corresponding to the display regions 20 and 30, and projection assemblys corresponding to the projection assemblys 2 and 3. Moreover, a control denoted by reference numeral 85 can be configured in accordance with the control 10.

FIG. 15 shows an exemplary embodiment of an engine compartment of the motor vehicle 70, reference numeral 100 denoting the engine of the motor vehicle 70. Arranged in the engine compartment are trim strips 101 and 102 having a fluorescing and/or phosphorescing substance for emitting light in a visible range upon irradiation by light in an at least virtually invisible range. The trim strips 101 and 102 are assigned a light source (not illustrated) corresponding to the light source 95 and arranged, for example, on the inside of the engine hood, for irradiating the trim strips 101 and 102 by light in the at least virtually invisible range.

Fluorescing and/or phosphorescing substances can be applied with reference to the inventions or to the previously described exemplary embodiments to plastic (for example polycarbonate, acrylic, polypropylene, polyethylene etc), to glass, to wood, to fabric, to mirrors, to leather, to rubber and/or to metal (aluminum, chromium, steel etc).

We claim:

1. A motor vehicle, comprising:
a passenger compartment with an interior covering formed with a display region configured to emit visible light upon irradiation of said display region by light in a substantially invisible range; and
a projection assembly for displaying information or images in said display region by irradiating said display region by light in the substantially invisible range.

2. The motor vehicle according to claim 1, wherein said projection assembly comprises a light source for emitting light in the substantially invisible range.

3. The motor vehicle according to claim 2, wherein said projection assembly further comprises a controllable image generator disposed in a light path between said light source and said display region.

4. The motor vehicle according to claim 1, wherein said display region is arranged on a dashboard.

5. The motor vehicle according to claim 1, wherein said display region is arranged on a rear side of a seat.

6. The motor vehicle according to claim 1, wherein said display region is arranged on a rear side of a headrest of a seat.

7. The motor vehicle according to claim 1, wherein said display region is arranged on a control device.

8. The motor vehicle according to claim 1, wherein the light is UV light in a virtually invisible range.

9. The motor vehicle according to claim 1, wherein a substantial portion of the light is at least virtually invisible light with a wavelength of approximately 405 nm±10 nm.

10. The motor vehicle according to claim 1, wherein the light in the at least virtually invisible range is essentially light with a wavelength of approximately 405 nm±10 nm.

11. The motor vehicle according to claim 1, wherein an overwhelming portion of the light in the at least virtually invisible range is light with a wavelength of approximately 405 nm±10 nm.

12. The motor vehicle according to claim 1, wherein the substantially invisible range is a wavelength range including invisible light and at least virtually invisible light.

13. A motor vehicle, comprising:
a control element for controlling a function of the motor vehicle, said control element being formed with an illuminable region configured to emit visible light upon irradiation of said illuminated region with light in a substantially invisible range; and
a light source for illuminating said illuminable region with light in the substantially invisible range.

14. The motor vehicle according to claim 13, wherein the substantially invisible range is a wavelength range including invisible light and/or at least virtually invisible light.

15. The motor vehicle according to claim 14, wherein the light in the invisible range or in the at least virtually invisible range is UV light.

16. The motor vehicle according to claim 13, wherein a substantial portion of the light is at least virtually invisible light with a wavelength of approximately 405 nm±10 nm.

17. The motor vehicle according to claim 13, wherein the light in the at least virtually invisible range is essentially light with a wavelength of approximately 405 nm±10 nm.

18. The motor vehicle according to claim 13, wherein an overwhelming portion of the light in the at least virtually invisible range is light with a wavelength of approximately 405 nm±10 nm.

19. The motor vehicle according to claim 13, wherein said illuminable region includes:
a first fluorescing and/or phosphorescing substance for emitting light in a visible range upon irradiation by light in a first, at least virtually invisible, range; and
a second fluorescing and/or phosphorescing substance for emitting light in a visible range upon irradiation by light in a second, at least virtually invisible, range different from the first range.

20. The motor vehicle according to claim 19, wherein said light source is configured for selectively irradiating said control element with light in the first range or with light in the second range.

21. The motor vehicle according to claim 19, wherein said control element is assigned a first function and at least one second function different from the first function, and wherein said light source is configured for irradiating said control element with light in the first range when said control element is assigned the first function, and for irradiating said control element with light in the second range when said control element is assigned the second function.

22. A motor vehicle, comprising:
a control element for operating at least two functions of the motor vehicle, said control element having a first fluorescing and/or phosphorescing substance for emitting light in a visible range upon irradiation by light in a first, at least virtually invisible, range, and a second fluorescing and/or phosphorescing substance for emitting light in a visible range upon irradiation by light in a second, at least virtually invisible, range different from the first range; and
a light source configured to selectively irradiate said control element either with the light in the first range or with light in the second range.

23. A motor vehicle, comprising:
an interior covering for covering an interior of the motor vehicle, at least a portion of said interior covering being configured as an illuminable region with a fluorescing and/or phosphorescing substance for emitting visible light upon irradiation by light in an invisible range or an at least virtually invisible range; and
a light source for irradiating a side of said illuminable region facing the interior of the motor vehicle with light in the invisible range or the at least virtually invisible range.

24. The motor vehicle according to claim 23, wherein said illuminable region is formed in a footwell of the interior.

25. The motor vehicle according to claim 23, wherein the light in the at least virtually invisible range is UV light.

26. The motor vehicle according to claim 21, wherein the light in the at least virtually invisible range is primarily light with a wavelength of approximately 405 nm±10 nm.

27. A motor vehicle with an interior, the motor vehicle comprising:
a trim strip disposed in the interior of the motor vehicle, said trim strip having a fluorescing or phosphorescing substance for emitting light in a visible range upon irradiation with light in an at least virtually invisible range; and
a light source for irradiating a side of said trim strip facing the interior of the motor vehicle with light in the at least virtually invisible range.

28. The motor vehicle according to claim 27, wherein said light source is coupled to a low beam of the motor vehicle.
